(19) United States
(12) Patent Application Publication
(10) Pub. No.: US 2002/0169661 A1
(43) Pub. Date: Nov. 14, 2002

(54) Virtual discount system

(75) Inventors: Scott Harvey Demsky, Austin, TX (US); Rabindranath Dutta, Austin, TX (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 09/852,827

(22) Filed: May 10, 2001

(51) Int. Cl. G06F 17/60

(52) U.S. Cl. 705/14

(57) ABSTRACT

A method and implementing system are provided in which a variety of items are offered for sale to customers through an interconnection network at a single web site. Different discounts for volume purchases or product group purchases made by customers are offered to the customers and the costs associated with the discounts are automatically allocated among a variety of product suppliers on a predetermined basis.

### FIELD OF THE INVENTION

The present invention relates generally to information processing systems and more particularly to a methodology and implementation for conducting business in a virtual store environment.

### BACKGROUND OF THE INVENTION

Use of the Internet to access and shop at web sites on the World Wide Web (the “web ”) is becoming more popular as the methods of doing business over the Internet, including payment methods, are improving. The ease with which purchases can be made through the Internet is a major factor in the growth of Internet shopping. More and more virtual stores are being created on the web so that shoppers may readily access any of many sites which have a presence on the web. There are, however, some aspects of web site shopping which are less than convenient for a web shopper. For example, many stores now specialize in a particular type of product, such as sporting shoes, and do not offer other products. Thus a web shopper has to access the shoe site, purchase the shoes desired by the shopper, and then exit the first web site or virtual store and access another web site or virtual store to purchase a related item such as running apparel. This procedure is tedious to the customer and improvements are needed.

In many cases, a customer will purchase items from several virtual stores and the total of the combined purchases may add up to a considerable amount. However, since the purchases were made at several different stores, the customer may not be able to receive a discount for the individual purchases.

Thus there is a need for an improved virtual store purchasing methodology by which purchasers may purchase a wider variety of goods at a single web site and be provided with volume discount credit from the single virtual store web site.

### SUMMARY OF THE INVENTION

A method and implementing system are provided in which a variety of items are offered for sale to customers through an interconnection network at a single web site. Different discounts for volume purchases or product group purchases made by customers are offered to the customers and the costs associated with the discounts are automatically allocated among a variety of product suppliers on a predetermined basis.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a virtual conglomerate store environment which utilizes the system of the present invention;

FIG. 2 is an exemplary block diagram of several of the major components of a computer system which may be used in an exemplary implementation of the present invention;

FIG. 3 is a specific example of a virtual conglomerate store in accordance with the present invention;

FIG. 4 is an example of a personalized account usage of the conglomerate example of FIG. 3;

FIG. 5 is an exemplary menu sequence which may be implemented and presented to a customer in accordance with the present invention;

FIG. 6 is a flow chart illustrating an exemplary methodology which may be implemented in practicing the present invention;

FIG. 7 is a continuation of the flow chart illustrated in FIG. 6;

FIG. 8 is a continuation of the flow chart illustrated in FIG. 7; and

FIG. 9 is a partial exemplary database structure which may be used in connection with the present invention.

### DETAILED DESCRIPTION

The various methods discussed herein may be implemented within a typical computer-related system which may include a workstation or personal computer. For example, a customer may access the Internet through a server device using a personal computer, a workstation or a wireless device, all of which have the same basic computer system functionality. In the example illustrated, the customer uses a personal computer and connects to a virtual store web site through an interconnection network such as the Internet. In general, an implementing computer system may include a plurality of processors in a multi-bus system in a network of similar systems. However, since the workstation or computer system used in practicing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although a personal computer is used as an example of an implementation of the present invention, it is understood that the device accessing the virtual store site may also be a workstation, or a wireless personal digital device, or even a cellular device such as a cellular phone.

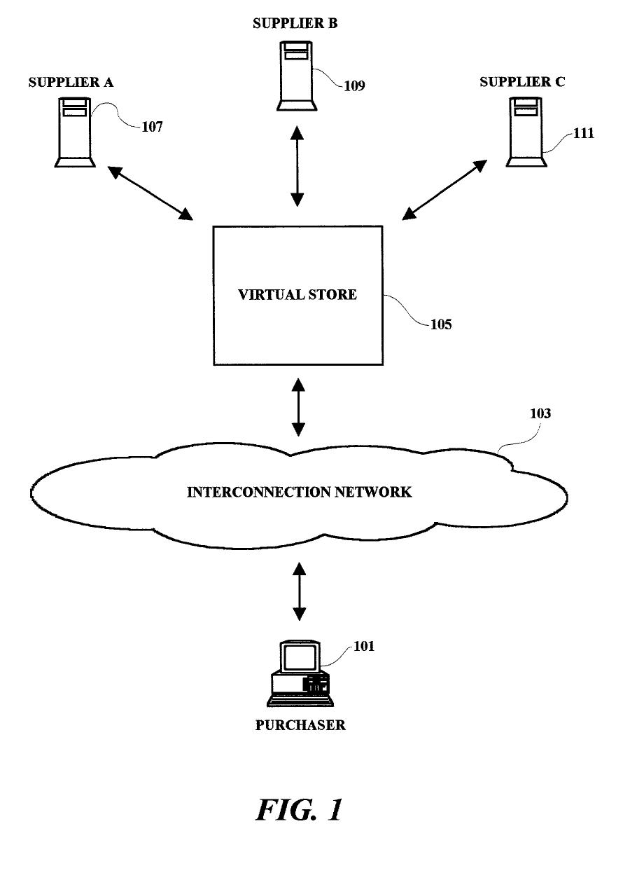

In FIG. 1, there is shown a computer terminal 101 which is connected through an interconnection network 103, such as the Internet, to a virtual store server 105. The virtual store server 105 is arranged to communicate with a plurality of supplier servers including Supplier A 107, Supplier B 109 and Supplier C 111. The virtual store server 105, in the present example, carries certain products from each supplier which are all offered for sale at the virtual store site 105. A purchaser is thus able to log on to the virtual store site 105 and order items that are provided from all of the suppliers at a single site without accessing different sites for different products. Further, the virtual store is enabled to offer discounts to purchasers based on volume or amount of purchase that would otherwise not be available if different products were purchased individually at different supplier sites. Purchasers who are made aware of the discount policy, will tend to purchase more of their needs at the virtual store (rather than at various different specialty stores) in order to take advantage of the available discounts and also because it is easier to do all of the customer's shopping at one site. One site shopping avoids unnecessary logging on and logging off, as well as remembering and inputting a number of different usernames, passwords, etc., that would be required in accessing a plurality of individual sites.

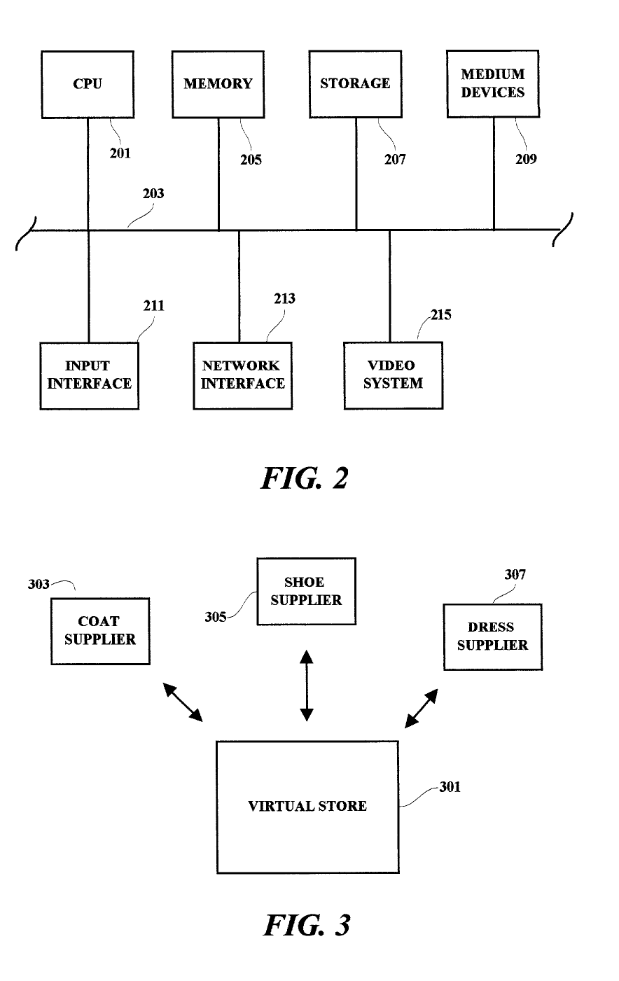

In FIG. 2, there is illustrated a block diagram of the exemplary computer system 101 which may be used by a purchaser in accessing the virtual store 105. As noted earlier, the components of the block diagram may be embodied in a personal or laptop computer, or a wireless or cellular device. As shown in FIG. 2 example, a central processing unit (CPU) 201 is connected to a system bus 203. The system bus is also connected to a memory device 205, a storage system 207, and medium devices 209 such as diskette and/or CD drives. Also shown is an input interface 211 to enable a user to input commands and menu selections. The input interface 211 may be connected to a keyboard and/or a mouse or other pointing device as is well known. The system bus is also selectively coupled to a network interface 213 which may be used to connect the purchaser device 101 to an interconnection network 103. The exemplary block diagram of FIG. 2 also includes a video system 215 which is used to display the various screen displays and selection options to the purchaser during a shopping transaction.

The virtual store 105 allows for discount pricing of goods based on product groups containing items from more than one supplier, and the cost of the discounts are shared among the suppliers based on a predetermined schedule. Products may be grouped by merchants or suppliers into a single discount group or products may be selected and grouped by customers into a single package which is then discounted by the virtual store.

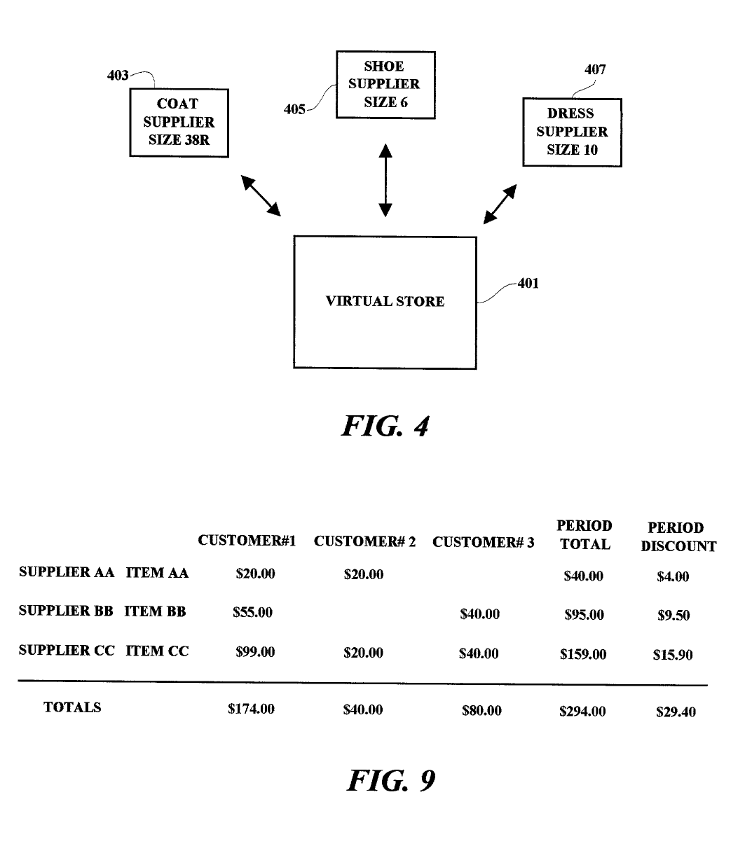

As shown in the FIG. 3 example, a virtual store 301 offers different products for sale which it receives from a coat supplier 303, a shoe supplier 305 and a dress supplier 307. In some applications, a purchaser may establish a personal account which includes the customer's sizes, for example, so that when the customer or purchaser logs on to the virtual store, only articles in the correct personal sizes, which are of record, are offered by the virtual store. This arrangement is illustrated in FIG. 4, in which a personal account includes coats from a coat supplier 403 in size “38R”, shoes from a shoe supplier 405 in size “6”, and dresses from a dress supplier 407 in size “10”, which are all offered for sale by the single virtual store 401. Personal accounts have the advantage that items that are not available in the correct size are not displayed or offered thereby eliminating unnecessary inquiry processing of items that are not available in the correct size for the particular shopper.

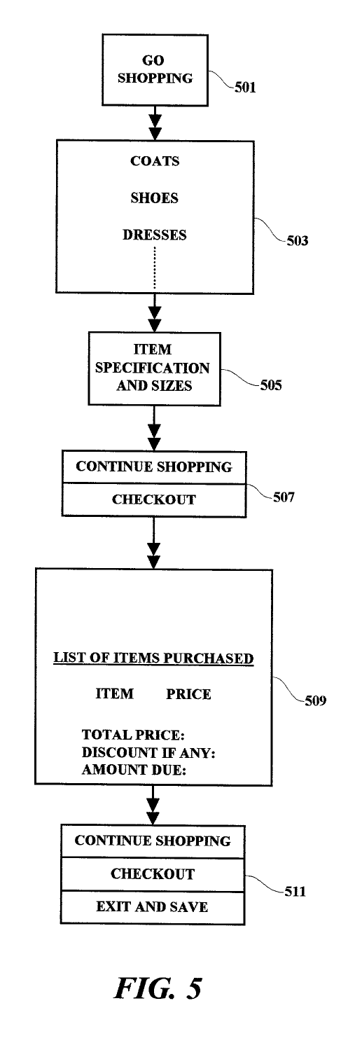

In FIG. 5, there is shown an exemplary schematic menu sequence which may be implemented in connection with the present invention. As illustrated, a shopper or purchaser is first presented with a menu from which the shopper may select to “GO SHOPPING” 501. At that point, a menu may be presented 503 to enable the shopper to select from a list of types of items available at the virtual store 105. As the shopper selects a particular type of item in which the shopper is interested, subsequent menus 505 may be presented to solicit more specific information from the shopper. After an item is specified and ordered, the shopper may be presented with a menu from which the shopper may select to continue shopping or to check-out 507. When the shopper is finished shopping, the total order of items selected is presented for confirmation by the buyer. The order confirmation, in the present example, includes a list of items selected along with the total price, and a calculated discount and the amount due after discount 509.

As hereinafter noted, the discount may be based upon the number and total price of the items selected by the shopper, and the discounts given to shoppers over a period of time are divided-up by the virtual store 105 and shared by the suppliers 107, 109 and 111 of the items purchased, in accordance with any of many possible predetermined discount schedules upon which the virtual store and the suppliers have agreed upon ahead of time. A final menu may be presented 511 to enable the shopper to continue shopping, checkout or exit and save the selected items for future reference. The checkout routine may include a menu sequence for enabling an input of credit card charge and other billing information.

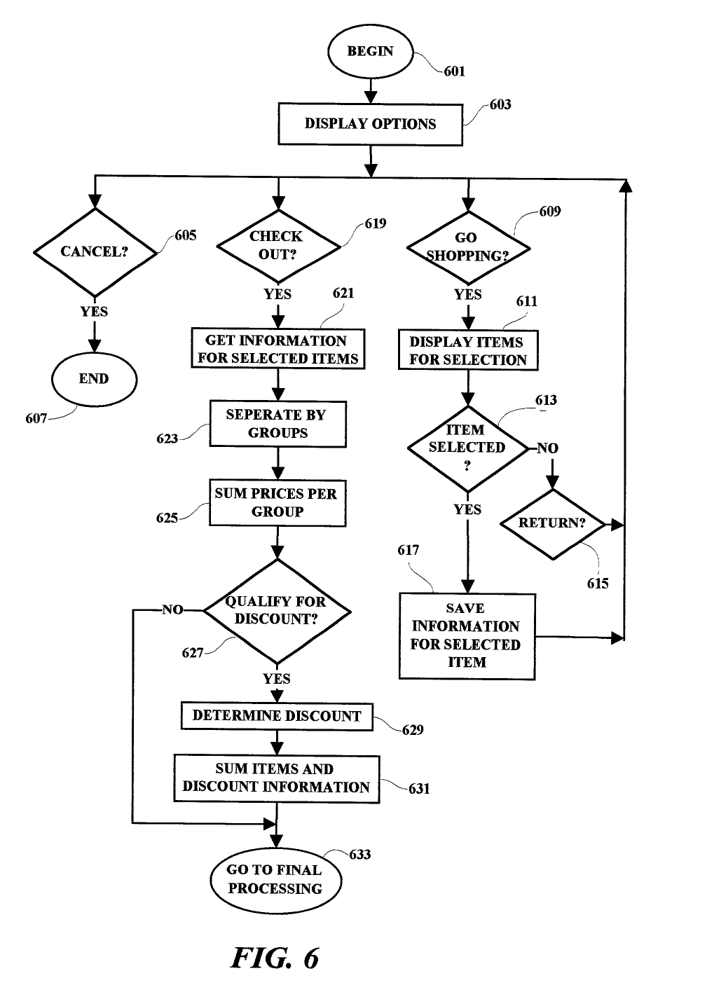

In FIG. 6, there is shown a flow chart which may be used in an exemplary embodiment of the present invention. It will be appreciated by those skilled in the art that the flow chart is readily converted into software code or logic hardware to enable the accomplishment of the designated functions. The methodology is illustrated in high level form to enable an implementation of the disclosed methods in any of many possible environments. As shown, when the processing begins 601, the various options are displayed 603 to a shopper. The shopper by operating a computer system such as a PC or a hand-held wireless device for example, may select an option from a displayed menu by pointing and clicking or highlighting an option and hitting an “ENTER” button. Other means of making selections in menu-driven applications may also be used. In the illustrated example, the shopper may select to “GO SHOPPING” 609, to “CHECK OUT” 619 or to “CANCEL” 605. If the shopper selects to “CANCEL” 605, the processing ends 607. If the shopper chooses to “GO SHOPPING” 609, then the items that are available for purchase are displayed 611 and the shopper is led through a series of menus in order to enable the shopper to further specify the item or items which the shopper wishes to purchase. For example, among other items displayed for selection, the virtual store may effect the display of one or more different products which are combined together in several groups. In this manner, discounts may be offered in connection with the displayed groups such that if a shopper purchases one of each type of item in one of the groups, then the shopper would be entitled to receive a first discount. Different discounts may apply to the purchase of items in different groups and the items in any group are combined from items supplied by different suppliers. If a shopper decides not to select an item 613 or make a purchase, the shopper may select an option to “RETURN” 615 to the main menu and CANCEL 605. If, however, a shopper selects an item to purchase 613, the purchasing information related to the selected item is saved 617 and the shopper is returned to the main menu where the shopper may then shop for additional items or check out 619 with the items previously selected.

When “CHECK OUT” is selected 619, the information for the previously selected items is retrieved 621 and separated by groups 623 as earlier defined to determine appropriate discounts. The prices for items in each group are summed 625 and a determination is made as to whether or not the purchase qualifies for any group or other discounts 627. If the purchase qualifies for a group or other discount 627, then the discount is determined 629 and the total numbers for the purchase and the discounts are calculated. Next, the methodology goes to a final processing function 633.

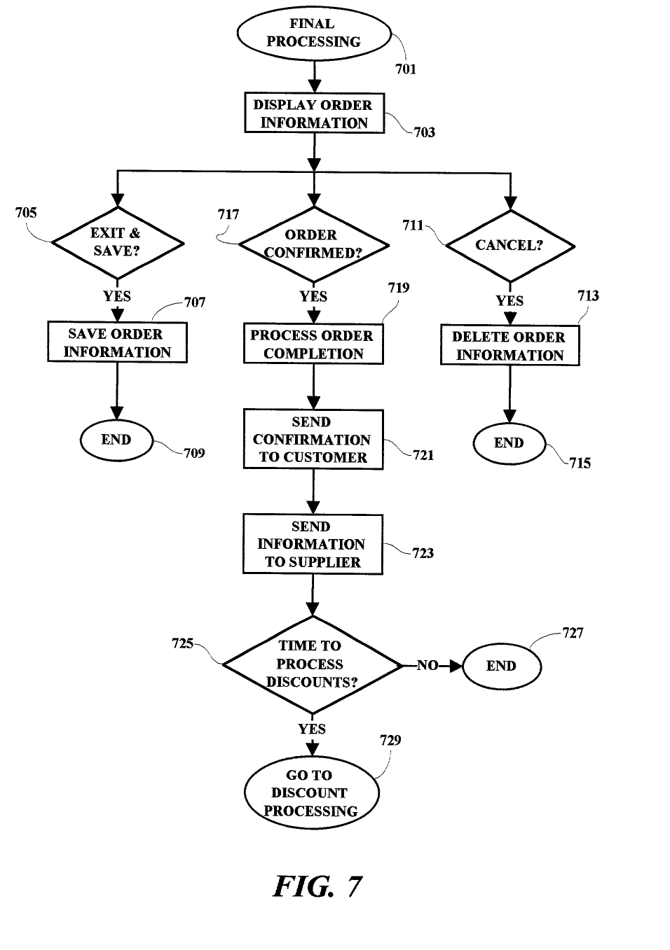

As shown in FIG. 7, the final processing 701 begins by displaying all of the order information including a description of the items purchased, the individual prices, the appropriate discounts and the final total order price. At that point, if the shopper or purchaser is not ready to make the purchase, the shopper may elect to “EXIT AND SAVE” 705, and return later to cancel or order. The order information is then saved 707 and the processing is ended 709. The exit and save function may include a default timer function such that if the shopper does not return to the virtual store within a certain period of time after saving, then the order information may be deleted by the virtual store. Alternatively, the shopper may simply cancel the order 711 whereupon the order information is deleted at that time and the process ends 715. If the shopper however, chooses to confirm the order 717, then order completion is processed 719. Order completion may include input by the shopper of the charge information to pay for the order. Confirmation of the order is then sent by email or otherwise to the customer or purchaser 721. Information concerning the discounts given to the shopper may then also be sent to the appropriate suppliers 723 by email or otherwise. A check is then made to determine if it is time to batch process the discounts to the suppliers 725. This may be done periodically, for example, on a monthly basis. If it is time to process the discounts to be shared by the suppliers 725, then the process continues to a discount processing function 729.

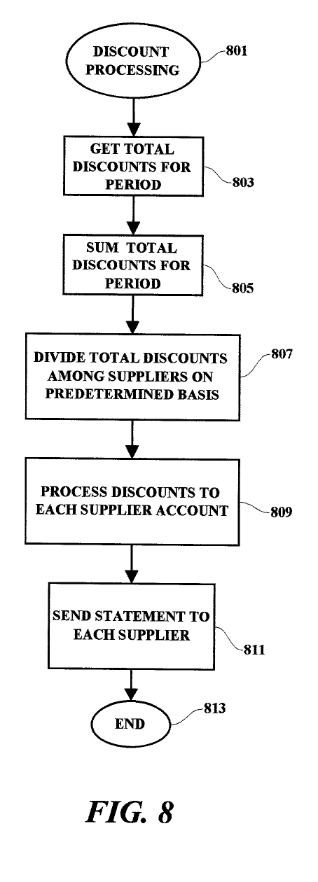

The discount processing function 801 shown in FIG. 8, begins by retrieving the total discounts for the period for each supplier 803. Next all of the discounts are summed 805 and divided among the suppliers 807 in accordance with a predetermined agreement between the virtual store and the suppliers. The calculated discounts are allocated among the accounts of the suppliers 809, a statement is sent to each supplier 811 and the processing is ended 813.

FIG. 9 illustrates an exemplary database in which the discounts to the suppliers may be determined. As shown, all of the customer purchases are grouped by supplier, then added together and discounted for the period for each supplier in accordance with a predetermined discount schedule. In the example shown in FIG. 9, all of the items receive a straight discount of 10%. However, as noted earlier, if some of the items are for group purchases and it was advertised that the group purchase of items will qualify for a 15% discount, then the shopper will have received a 15% discount and the suppliers will share the cost of the 15% discount. In all of the examples, in addition to absorbing the costs of the discounts, the suppliers would also be billed for a seller's commission for the virtual store site.

In another example of a possible discount methodology, all of the suppliers may agree on a single volume discount schedule such that sales over $100 will receive a 10% discount, sales over $150 would receive a 12% discount and sales over $200 would receive a 15% discount. As each sale is made to customers during a month, the appropriate discount is calculated and presented to the customer to confirm the sale as hereinbefore described. At the end of the accounting period, each supplier will have had sales which would qualify for different discounts. For example, a $90 sale would have no discount, a $125 sale would have a discount of 10% or $12.50, and a sale of $270 would have a 15% discount or a discount of $40.50. The appropriate discounts are calculated at the time of the sale and presented to the buyer for confirmation, and the total discounts for each supplier during the period are calculated at the end of every accounting period and (along with a sales commission) are notified to each supplier as appropriate.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling an implementation of a discount processing technique for a virtual store, said method comprising:
providing a discount schedule for a number of different suppliers of items offered for sale at said virtual store;
presenting display screens describing said items to customers, said display screen including descriptions of discounts which are available for different groups of said items in accordance with said discount schedule;
enabling a selection of items by said customers; and
presenting a purchase summary to said customers, said purchase summary including prices for selected items together with appropriate discounts as determined in accordance with said discount schedule.

2. The method as set forth in claim 1 wherein said discount schedule is comprised of a database containing individual discount schemes for a number of different suppliers.

3. The method as set forth in claim 2 wherein said discount schedule is referenced to volume purchase levels.

4. The method as set forth in claim 2 wherein said discount schedule is referenced to groupings of items selected.

5. The method as set forth in claim 1 and further including:
enabling a confirmation of said purchase summary by said customer whereby said customer is able to confirm the purchase of the selected items by the customer.

6. The method as set forth in claim 5 and further including:
saving sales information records relating to purchases of selected items during a predetermined period;
extracting predetermined supplier related information from said sales information records; and
notifying each of said suppliers with appropriate portions of said extracted supplier related information.

7. The method as set for in claim 6 wherein said notifying is accomplished at periodic intervals.

8. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable an implementation of a discount processing technique for a virtual store, said program signals being selectively operable for:
providing a discount schedule for a number of different suppliers of items offered for sale at said virtual store;
presenting display screens describing said items to customers, said display screen including descriptions of discounts which are available for different groups of said items in accordance with said discount schedule;
enabling a selection of items by said customers; and
presenting a purchase summary to said customers, said purchase summary including prices for selected items together with appropriate discounts as determined in accordance with said discount schedule.

9. The medium as set forth in claim 8 wherein said discount schedule is comprised of a database containing individual discount schemes for a number of different suppliers.

10. The medium as set forth in claim 9 wherein said discount schedule is referenced to volume purchase levels.

11. The medium as set forth in claim 9 wherein said discount schedule is referenced to groupings of items selected.

12. The medium as set forth in claim 8 wherein said program signals are further effective for:
enabling a confirmation of said purchase summary by said customer whereby said customer is able to confirm the purchase of the selected items by the customer.

13. The medium as set forth in claim 12 wherein said program signals are further effective for:
saving sales information records relating to purchases of selected items during a predetermined period;
extracting predetermined supplier related information from said sales information records; and
notifying each of said suppliers with appropriate portions of said extracted supplier related information.

14. The medium as set for in claim 13 wherein said notifying is accomplished at periodic intervals.

15. A virtual store computer system for use in operating a virtual store in which items are offered for sale, said virtual store computer system comprising:
a system bus;
a CPU device connected to said system bus;
a memory device connected to said system bus; and
means for receiving input from a customer system with reference to screens caused by said virtual store computer system to be displayed on a display screen within said customer system, said memory device including a discount schedule for a number of different suppliers of items offered for sale at said virtual store, said virtual store computer system being selectively operable for:
presenting display screens to said customers describing said items to customers, said display screens including descriptions of discounts which are available for different groups of said items in accordance with said discount schedule,
enabling a selection of items by said customers; and
presenting a purchase summary to said customers, said purchase summary including prices for selected items together with appropriate discounts as determined in accordance with said discount schedule.

16. The virtual store computer system as set forth in claim 15 wherein said discount schedule is comprised of a database containing individual discount schemes for a number of different suppliers.

17. The virtual store computer system as set forth in claim 16 wherein said discount schedule is referenced to volume purchase levels.

18. The virtual store computer system as set forth in claim 16 wherein said discount schedule is referenced to groupings of items selected.

19. The virtual store computer system as set forth in claim 15 wherein said program signals are further effective for:
enabling a confirmation of said purchase summary by said customer whereby said customer is able to confirm the purchase of the selected items by the customer.

20. The virtual store computer system as set forth in claim 19 wherein said program signals are further effective for:
saving sales information records relating to purchases of selected items during a predetermined period;
extracting predetermined supplier related information from said sales information records; and
notifying each of said suppliers with appropriate portions of said extracted supplier related information.

21. The virtual store computer system as set for in claim 20 wherein said notifying is accomplished at periodic intervals.
